(19) United States
(12) Patent Application Publication
(10) Pub. No.: US 2012/0111870 A1
(43) Pub. Date: May 10, 2012

(54) INSTALLATION COMPONENT FOR A TANK, APPARATUS FOR DETERMINING A FILL LEVEL OF A TANK, METHOD FOR PRODUCING AN INSTALLATION COMPONENT, TANK AND MOTOR VEHICLE HAVING A TANK

(75) Inventors: JAN HODGSON, TROISDORF (DE); SVEN SCHEPERS, TROISDORF (DE); ROLF BRÜCK, BERGISCH GLADBACH (DE)

(73) Assignee: EMITEC GESELLSCHAFT FÜR EMISSIONSTECHNOLOGIE MBH, LOHMAR (DE)

(21) Appl. No.: 13/337,707

(22) Filed: Dec. 27, 2011

Related U.S. Application Data
(63) Continuation of application No. PCT/EP2010/058577, filed on Jun. 17, 2010.

(30) Foreign Application Priority Data
Jun. 26, 2009 (DE) 10 2009 030 674.9

(51) Int. Cl. B65D 25/02; G01F 23/22; B05D 5/12

(52) U.S. Cl. 220/562; 220/200; 427/58; 73/304 R

(57) ABSTRACT

An installation component for a tank includes, at least in parts, an electrically conductive material which forms a first electrode, and a second electrode which is electrically insulated with respect to the first electrode. At least one of the electrodes is applied to the installation component, in particular by a pad printing process, an airbrush printing process or a screen printing process. An apparatus for determining a fill level of a tank, a method for producing an installation component, a tank and a motor vehicle having a tank, are also provided.

### CROSS-REFERENCE TO RELATED APPLICATION

This is a continuation, under 35 U.S.C. §120, of copending International Application No. PCT/EP2010/058577, filed Jun. 17, 2010, which designated the United States; this application also claims the priority, under 35 U.S.C. §119, of German Patent Application DE 10 2009 030 674.9, filed Jun. 26, 2009; the prior applications are herewith incorporated by reference in their entirety.

### BACKGROUND OF THE INVENTION

### Field of Invention

The present invention relates to an installation component for a tank, an apparatus for determining a fill level of a tank, a method for producing an installation component, a tank and a motor vehicle having a tank, in particular a tank with a urea-water solution, in which a tank fill level and/or a quality of tank contents are determined. Since a urea-water solution is often used for the purification of exhaust gases of mobile internal combustion engines, the invention relates in particular to an apparatus for use in the automotive field.

Urea-water solution is used, in particular, within the so-called SCR process (SCR: Selective Catalytic Reaction) for the treatment of exhaust gases. It is an aim of that process to reduce the nitrogen oxides present in the exhaust gas. In that case, ammonia or the ammonia precursor urea is often proposed as a reducing agent. In that case, the ammonia or the urea-water solution is generally added as a function of the nitrogen oxides to be broken down in the exhaust gas. The reducing agent is thus an operating medium, the storage of which must be monitored. Furthermore, it must be taken into consideration that specifically the quality of the urea-water solution is also of interest in that case, because it is only in that way that it can be ensured that the required quantity of ammonia is generated which is needed during the operation of the internal combustion engine, in particular a diesel engine.

Due to future regulations, it may also become necessary to retrofit existing exhaust systems with an SCR system. For that purpose, it is necessary for the components of the SCR system to have a compact construction and be easily adaptable to the existing exhaust system. There is presently still a considerable amount of development to be carried out in that regard. The known fill level measurement systems and/or quality measurement systems have a complex construction and/or are highly sensitive to dynamic movements of the tank contents during operation of the motor vehicle.

### SUMMARY OF THE INVENTION

It is accordingly an object of the invention to provide an installation component for a tank, an apparatus for determining a fill level of a tank, a method for producing an installation component, a tank and a motor vehicle having a tank, which overcome the hereinafore-mentioned disadvantages and at least partially solve the highlighted problems of the heretofore-known devices and methods of this general type. In particular, it is sought to specify an installation component for a tank, wherein the installation component is used, in particular, in an apparatus for determining a tank fill level and/or for measuring the quality of the liquid in the tank, in such a way that the number of required components can be reduced and as a result, simple production of the installation component can also be attained.

With the foregoing and other objects in view there is provided, in accordance with the invention, an installation component for a tank. The installation component comprises a first electrode formed of an electrically conductive material of at least parts of the installation component and a second electrode electrically insulated from the first electrode. At least the second electrode is applied on the installation component.

Consequently, at least one electrode, but in particular two or even all three electrodes, is/are applied to the installation component. An “applied” electrode is captively, in particular cohesively, connected to the installation component. For this purpose, the material of the electrode is applied to the installation component (one piece at a time or initially without a contour) and then if appropriate solidified or fixed. It is likewise possible for a type of (if appropriate multi-layer) coating to be provided on the installation component, which coating is retroactively (partially) removed again in order to attain the desired contour of the electrode. In this case, in particular “film-like” embodiments of the electrodes are possible, for example with a maximum thickness of 200 μm [micrometers]. A preferred embodiment of an “applied” electrode is an electrode with a layered construction and/or a printed electrode.

Airbrush printing processes, a pad printing process and/or a screen printing process are used, in particular, as the printing process.

In this case, the pad printing process is an indirect printing process, wherein a printing mold bears in its surface a recessed print layout to be printed. If the printing mold is filled with the material to be printed, the material is picked up, in the form of the print layout, by a pad, composed in particular of silicone rubber, from the recessed print layout. The pad is subsequently moved over the installation component and, there, applies the print layout to the installation component by virtue of the pad being pushed on or pressed on and/or by virtue of the pad being rolled on. The advantage of this method of print transfer is the deformability of the pad, as a result of which it is possible to print onto curved, convex, concave or irregular surfaces. Due to its elasticity, the pad takes on the shape of the body to be printed on, and can thus transfer the contour of the electrode to the installation component in a particularly effective manner. The print layout is thus transferred to the print body (the installation component).

A further possible way in which the electrode material can be applied is through the use of an airbrush system, that is to say through the use of a spraying process, wherein a mask is placed onto the installation component and the electrode material is applied to the installation component through the mask. Electrically insulating coatings which are at the same time corrosion resistant (in particular to a urea-water solution) can also be applied to the electrode material and/or to the installation component using similar methods, in such a way that the individual electrodes (fill level electrode, reference electrode, ground electrode) can be formed in this way.

Furthermore, it is also possible to use the screen printing process, in which a partially impenetrable screen serves as a template for the application of the material of the electrode. Depending on the material used, hardening, fixing or the like may then be required in order to realize a firm connection to the support material (in this case the installation component).

As a result of the application of the electrodes to the installation component through the use of a printing process, it is possible for installation components to be provided with various electrodes and interposed electric insulation using a simple and reliable production process. In particular, through the use of these methods, it is possible to ensure high accuracy in the reproducibility of the application process, in particular with regard to mass production of installation components produced in this way. Furthermore, it is possible, through the use of such printing processes in particular, to form thin electrodes or coatings (in particular less than 200 μm) in such a way that a small amount of material is applied and therefore only low material costs are incurred.

Furthermore, it is also considered to be advantageous for at least one of the electrodes to be adhesively bonded to the installation component. In this case, the adhesive used has an electrically insulating action, in such a way that electric contact between electrode and installation component is prevented in a targeted manner.

In particular, through the use of these methods, the number of components is, however, also reduced, and the production of an installation component is greatly simplified. Whereas it was previously the case that separate prefabricated electrodes had to be welded on, soldered, adhesively bonded or the like in successive steps, it is the case with this method that the installation component is provided directly with the electrodes through the use of the printing process without the need for any assembly steps. The complexity of the conventional assembly methods is thus considerably reduced and simplified. This permits a reduction in production costs with simultaneous high reproducibility and low material costs.

The following materials, in particular, are suitable for the electrode material for pad printing, for screen printing and for the spraying (airbrush) method: silver-palladium, silver-platinum and/or gold.

The following materials may be used, in particular, for the printing onto the installation component in the electrode regions and for the electric insulation between the electrodes and the installation component and between the electrodes: glass including calcium aluminum silicate or boron alumina or the like.

The tank for which the installation component according to the invention is provided serves, particularly preferably, for storing an operating fluid for a motor vehicle. The operating fluid is particularly preferably a (liquid) reducing agent for supplying into an exhaust-gas treatment device, and in particular a urea-water solution. It is important for the operating fluid to have significant electrical properties in order to permit the determination of the fill level through the use of electrodes.

In accordance with another preferred structural variant of the installation component of the invention, the installation component includes an extraction pipe. In a further structural variant, the installation component is an extraction pipe. The electrodes are then preferably applied to the surface of the extraction pipe. The electrodes on the installation component serve for determining the fill level in a tank. The determination of the fill level should be as precise as possible for different fill levels of liquid in the tank. It is therefore preferable for the electrodes on the installation component to be in electrical contact with the liquid in the tank at different fill levels in the tank. An extraction pipe for extracting liquid from the tank typically extends over at least a part of the height of the tank. The surface of the extraction pipe is therefore in electrical contact with the liquid at different fill levels of the liquid in the tank.

In accordance with a further preferred structural variant of the installation component of the invention, a dosing unit for an operating fluid is provided in the installation component. It is advantageous for the dosing unit for delivering an operating fluid out of a tank to be provided in an installation component in the tank. A particularly space-saving configuration of the dosing unit is thus possible. The electrodes can then be provided on a surface of the installation component (for example a housing for the dosing unit or some other functional component) and be in contact with the liquid in the tank.

In accordance with an added preferred refinement of the installation component of the invention, a third electrode, which is provided in the installation component, is printed onto the installation component and is electrically insulated with respect to the installation component and the second electrode. The third electrode may take some other form, for example it may be a longitudinal electrode (an electrode with an elongate construction), whereas the second electrode may, for example, be partially covered by the electrically insulating material again so as to constitute a spot electrode (an electrode with a short, for example punctiform construction).

With the objects of the invention in view, there is also provided an apparatus for determining a tank fill level and/or for determining a quality of the tank content. The apparatus comprises the installation component according to the invention and a cap, with the installation component extending through the cap. If a dosing unit for the operating fluid is disposed in the installation component, the cap may simultaneously serve as a cover for closing off the installation component toward the outside of the tank.

In accordance with another feature of the invention, a measuring unit may be provided which is connected at least to the first or the second electrode and, if appropriate, also to the third electrode, for the transmission of measurement values of the electrodes.

The apparatus described herein is preferably an independent component which can, in particular, replace conventional tank closure elements or tank covers. In this case, the cap has, for example, a corresponding screw connection and/or seal through the use of which it can be fastened to a tank. The cap furthermore permits the fixing and alignment of the installation component in the tank, wherein if appropriate the measuring unit is situated on the opposite, outer side of the cap. It is self-evident that the cap may also have further components, for example cables, heating resistors, sensors, terminals, adapters, pressure valves, etc.

The installation component serves for the extraction of the tank contents, for example a urea-water solution. For this purpose, the installation component is connected, outside the tank or else within the tank, for example to a pump through the use of which the tank contents are conveyed out through the installation component and finally added to the exhaust gas. The pump may also be provided within a dosing unit disposed in the installation component. The installation component is preferably formed entirely from an electrically conductive material, wherein that material is in particular also resistant to the urea-water solution. The material which is used for the installation component is, in particular, a metal which is corrosion-resistant with respect to solutions of reducing agent precursors (for example urea). A high-grade steel, an austenitic steel, a chromium-nickel steel and/or a nickel-based material is particularly advantageously used in this case.

The measuring unit may, in particular, also take the form of a data processing unit. The processing of the electrical signals can thus be carried out in this case directly in the measuring unit. It is likewise possible for the measuring unit to have data models stored in it which permit an analysis or evaluation of the electrical signals. For this purpose, the measuring unit may form corresponding electrical circuits and connections to other constituent parts of the apparatus and of a motor vehicle.

Furthermore, it is proposed that the installation component and the electrodes be used for a capacitive fill level measurement. The first electrode and the second electrode form an electrical capacitor for the determination of the tank fill level and/or of the quality/composition of the tank content. If the electrodes are situated in a space filled with air, a low starting capacitance can be measured. If the tank fill level is increased, the capacitance increases as the extent to which the electrodes are covered increases. With such capacitive fill level measurements, it is possible, in particular, to realize a continuous fill level measurement because the detected electrical signals can, if appropriate, be compared with reference data. If appropriate, the measuring unit may also have amplifiers and similar elements in order to improve the signal evaluation. It is possible to determine, for example, the electrical resistance, the capacitance or similar variables between the electrodes as an electrical variable.

In this way, it is possible, in a particularly simple manner, for statements to be made regarding the fill level using just the two electrodes on the installation component. In this regard, it is also advantageous for the electrically non-conductive (insulated) region between the two electrodes to have a certain height. In other words, this means for example that, if the lower part of the installation component is coated with insulation up to a height (for example the distance from the lowest point of the tank interior) of approximately 2 cm, a reserve indicator can be generated. Specifically, if the fill level falls below the electrically insulated height, conductivity can no longer be measured, which is an indication that the reserve has been reached. When an adequate delivery pressure can no longer be generated in the feed system for the exhaust system, for example, this shows that the tank is finally empty.

It is thereby possible, in particular, to also realize the following configurations:
a) Reserve indicator:
The structure includes two electrodes which are applied to an electrically insulated substrate and which are likewise covered in the upper region by electrically insulating material. In this way, for example, only two spot electrodes are provided on the installation component at a predefined position, which spot electrodes are checked for electrical conductivity. If this is no longer the case, “only” air is situated between the electrodes. The tank has now reached the reserve region.
b) Fill level indicator:
In this case, in addition to the construction according to a), a longitudinal electrode may additionally be provided which can continuously generate signals in order to thereby output to the user information characteristic of the fill level.

In accordance with a further refinement of the invention, the measuring unit is disposed on the cap. In other words, this also means that the measuring unit, in particular together with the electronics required for it, is mounted in a protected manner on the outside of the cap or within the cap. For this purpose, the cap may be formed with a separate housing which is sealed with respect to the environment. It is also possible for the measuring unit together with the required electronics to be disposed within the installation component.

The preferred embodiment of the apparatus, with three electrodes, permits not only the determination of the fill level but also, if appropriate, the determination of the quality/composition of the liquid in the tank or of the urea-water solution. It is basically possible, for example, for the first electrode to be used as a reference electrode, for the second electrode to be used as a ground electrode, and for the third electrode to be used as a level electrode. In this case, the measuring unit is connected to all of the electrodes, wherein in particular the measurement of the capacitance between different electrodes allows statements to be made in each case regarding the quality and/or the fill level. For example, the capacitance and/or the resistance of the urea solution can be determined through the use of voltages and currents between the reference electrode and the ground electrode and between the ground electrode and the level electrode. Urea solutions used in the automotive field generally have a known resistivity and known dielectric properties. It is thereby possible, through the use of a differential rectifier circuit in the measuring unit, to determine the fill level from capacitances and/or resistances determined between the electrodes.

The resistance (R) between two non-insulated electrodes, which are disposed with a spacing (l) in a tank containing urea solution, have a width (b) and run vertically over the entire height of the tank, can be obtained approximately by using the following formula as a function of the fill level (h) and of the resistivity of the urea-solution (ρ), for example:

$$R = ρ \cdot \frac{l}{b \cdot h}$$

As the fill level rises, the resistance between the electrodes thus decreases, whereas a falling fill level results in an increasing resistance. In the case of another, possibly more complex geometric configuration of the electrodes relative to one another in the tank, a person skilled in the art can, on the basis of this formula, develop appropriate formulae for calculating the resistance as a function of the fill level.

Furthermore, it is considered to be advantageous for the first electrode to be coated with an electrically non-conductive (insulating) material from the cap up to a certain point on the installation component, and to therefore be insulated from the tank contents up to this point, and to thereby be formed as a reference electrode. The second electrode can preferably make electrically conductive contact with the tank contents over its entire length. Since the non-coated region of the reference electrode is constantly covered by liquid or a urea solution, the resistivity of the urea solution is determined between the reference electrode and the ground electrode, in such a way that a quality measurement of the urea solution can be realized in this way. This is achieved by virtue of a voltage being applied between the two electrodes, in such a way that the resulting measurement values are dependent only on the composition of the liquid situated between the electrodes. From this, it is possible to make statements regarding the water fraction and the urea fraction in a urea-water solution.

Furthermore, it is also possible for the second electrode and a third electrode to be connected to a voltage source. It is self-evident that the voltage source may be the same for all three electrodes. In this case, the second electrode and the third electrode may, in particular, be used for detecting the fill level, because the tank is filled with the tank contents in the intermediate space between the second electrode and third electrode, and different voltages can be detected between the electrodes as a result of the increasing wetting thereof as the tank is filled and the decreasing wetting thereof as the tank empties. For this purpose, the third electrode can likewise make electrically conductive contact with the tank contents proceeding from the cap. The third electrode preferably extends only up to the height of the coating of the first electrode. In particular, the third electrode thus ends, or changes its profile, at that level of the tank at which the reserve region is reached. Considerable measurement value changes can be detected in this case, which can be used as a signal for a corresponding display.

With the objects of the invention in view, there is additionally provided a method for producing an installation component for a tank. The method comprises printing at least one of the electrodes onto the installation component using one of the following processes:
a) an airbrush printing process;
b) a pad printing process; or
c) a screen printing process.

With the objects of the invention in view, there is furthermore provided a tank, comprising the compact, functional and modular apparatus, which has a simple construction, according to the invention. It is also proposed, therefore, for the tank for the urea-water solution to have an opening for extracting urea-water solution, wherein the opening can be closed off through the use of the cap of an apparatus described according to the invention.

In accordance with another particularly preferable feature of the invention, the opening is provided in the base of the tank. An installation component according to the invention can then be inserted into the tank from below. The installation component preferably also includes a dosing unit for the operating fluid in the tank.

With the objects of the invention in view, there is concomitantly provided, specifically for the application, described in the introduction, for realizing an SCR system, a motor vehicle, comprising a tank as specified above and a controller which is connected at least to the first electrode and to the second electrode and/or to the measuring unit. The controller may, for example, be the engine management system of the motor vehicle, wherein this too is set up for the metered addition, according to demand, of urea-water solution into the exhaust system of the motor vehicle.

Other features which are considered as characteristic for the invention are set forth in the appended claims, noting that the features specified individually in the claims may be combined with one another in any desired technologically expedient manner and form further embodiments of the invention.

Although the invention is illustrated and described herein as embodied in an installation component for a tank, an apparatus for determining a fill level of a tank, a method for producing an installation component, a tank and a motor vehicle having a tank, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, vertical-sectional view of a tank having a first structural variant of an installation component according to the invention; and

FIG. 2 is a vertical-sectional view of a tank having a second structural variant of an installation component according to the invention.

### DETAILED DESCRIPTION OF THE INVENTION

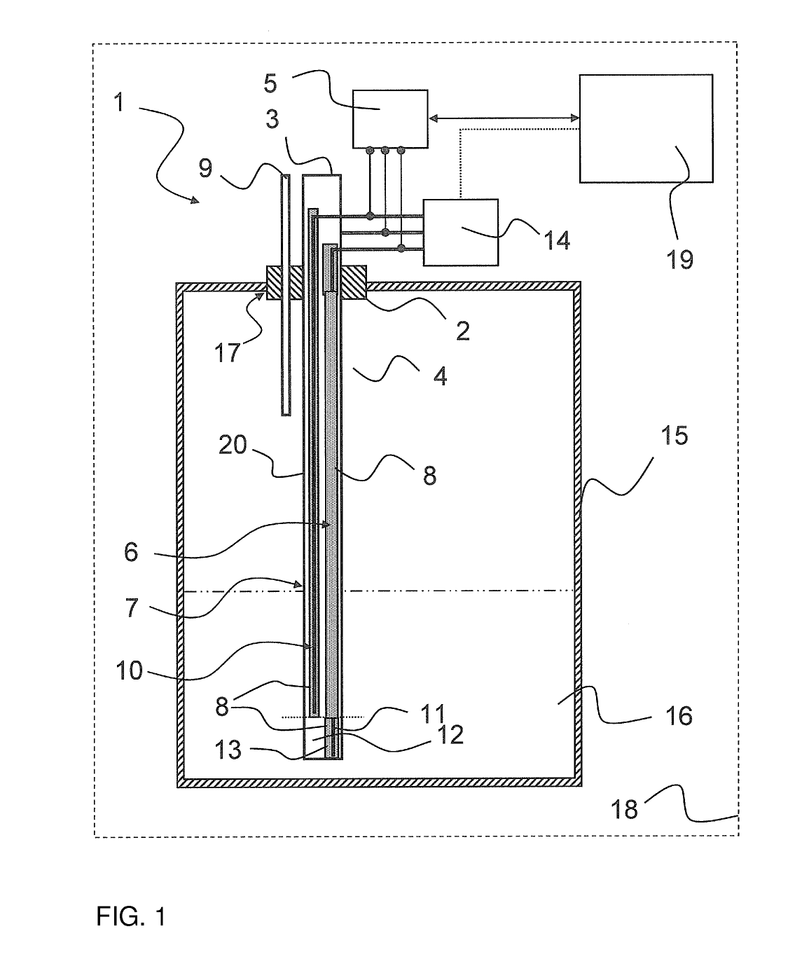

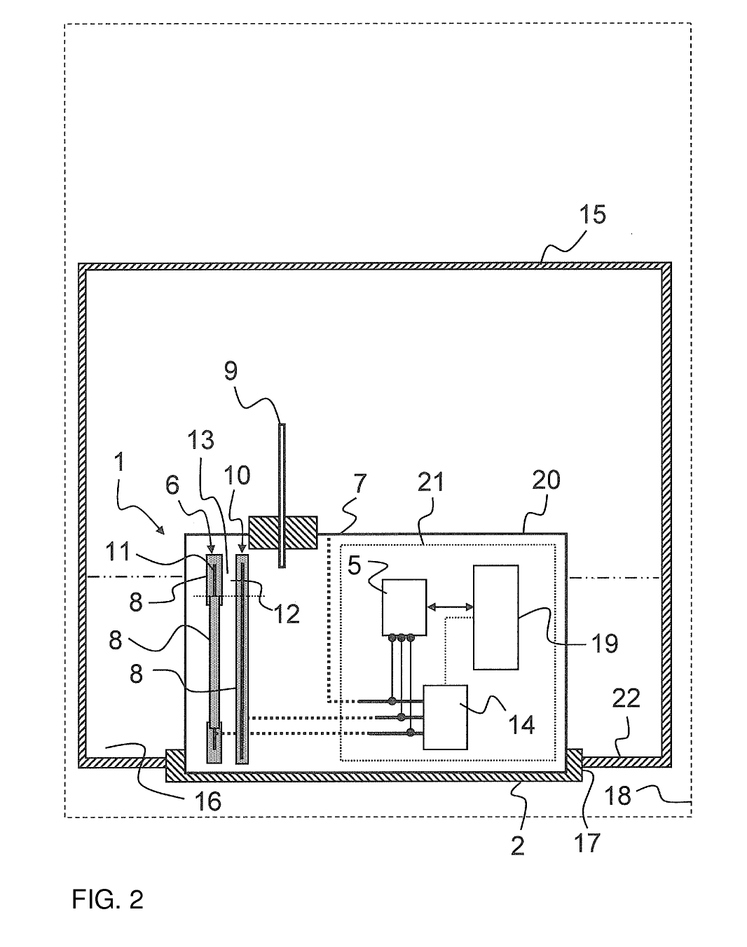

Referring now in detail to FIGS. 1 and 2 of the drawing for explaining the invention and the technical field in more detail by showing particularly preferred structural variants to which the invention is not restricted, there are seen diagrammatic sectional views of tanks 15 according to two different structural variants of an installation component 20 according to the invention. In FIGS. 1 and 2, many components are denoted by the same reference numerals, so that the two figures will initially be described jointly herein. Each of the figures shows an apparatus 1 for determining a tank fill level. In this case, the tank 15 is a storage vessel for a urea-water solution 16. The tank 15 is furthermore part of a motor vehicle 18, which is diagrammatically indicated herein.

The tank 15 illustrated in FIG. 1 has, in a top region, an opening 17 into which a cap 2 is inserted as a closure for the tank 15. The tank 15 and the cap 2 are preferably produced from plastic, for example polyethylene.

In this case, a pipe, specifically an extraction pipe 3 for the extraction of the urea-water solution 16 from the tank 15, extends through the cap 2. In the structural variant according to FIG. 1, the extraction pipe 3 forms the installation component 20.

The tank 15, which is illustrated in FIG. 2, has a base 22 with an opening 17, into which the installation component 20 is inserted. In this case, the installation component 20 is constructed as a housing in which a dosing unit 21 for the urea-water solution 16 in the tank is situated. In FIG. 2, the installation component 20 also extends through a cap 2 with which it is inserted into the opening 17.

In both structural variants, it is also possible, if appropriate, for a return pipe 9 to be provided, through which extracted but surplus urea-water solution 16 can be conducted back into the tank 15.

Furthermore, in both structural variants, a measuring unit 5 and a voltage source 14 are provided. In FIG. 1, the measuring unit 5 and the voltage source 14 are positioned at the outside on the cap 2. In FIG. 2, the measuring unit 5 and the voltage source 14 are provided within the installation component 20. The measuring unit 5 and the voltage source 14 are both connected in an electrically conductive fashion to a first electrode 6, a second electrode 7 and, if appropriate, a third electrode 10. In this case, the fill level may be detected, for example, between the third electrode 10 and the second electrode 7 over a large range of variation of the fill level of the urea-water solution 16. In FIGS. 1 and 2, the second electrode 7 is formed by the installation component 20.

In both embodiments, the first electrode 6 and the second electrode 7 furthermore have a first electrode end portion 11 and a second electrode end portion 12 on a side facing away from the cap 2. In this case, the electrode end portions 11, 12 together form a free space 13 between the electrodes 6, 7. The second electrode end portion 12 of the second electrode 7 is formed by a metallic surface of the installation component 20 in the direct vicinity of the first electrode end portion 11. The second electrode end portion 12 is that region of the surface of the installation component 20 which interacts significantly with the first electrode end portion 11 during the fill level measurement. For this purpose, the first electrode 6 is provided, from the cap 2 to the electrode end portion 11, with a coating 8 which provides insulation with respect to the urea-water solution 16. A continuous insulating coating 8 is likewise provided on the installation component 20 in each case below the first electrode 6 and the third electrode 10. The first electrode 6 and the third electrode 10 are insulated with respect to the installation component 20 by the coating 8.

If appropriate, the insulated regions with the electrode portions may also additionally be provided with concentric shielding in order, for example, to counteract flow fluctuations and the like. In this case, urea-water solution 16 can penetrate into the free space 13 or, in the region of the free space, the urea-water solution can produce a direct electrical connection between the first electrode 6 and the second electrode 7. In this case, by providing a constant height of the electrode end portions and by using the measurement, statements can be made regarding the quality of the urea-water solution 16. The type of measurement, the time of the measurement and/or the evaluation of the measurement may, if appropriate, also be initiated or carried out through the use of a controller 19 of the motor vehicle 18. The controller is therefore, in particular, connected in data-exchanging fashion to the measuring unit 5 and/or operates the voltage source 14 for the measurement according to demand.

The return line 9 illustrated in both structural variants may serve as an additional electrode, and for this purpose may optionally likewise be connected to the measuring unit and/or to the voltage source 14 for the measurement.

1. An installation component for a tank, the installation component comprising:
a first electrode formed of an electrically conductive material of at least parts of the installation component; and
a second electrode electrically insulated from said first electrode;
at least said second electrode being applied on the installation component.

2. The installation component according to claim 1, which further comprises an extraction pipe.

3. The installation component according to claim 1, which further comprises a dosing unit for an operating fluid.

4. The installation component according to claim 2, which further comprises a third electrode printed onto the installation component and electrically insulated from said extraction pipe and said second electrode.

5. An apparatus for determining a fill level of a tank, the apparatus comprising:
a cap; and
an installation component according to claim 1 extended through said cap.

6. A method for producing an installation component for a tank, the method comprising the following steps:
providing a first electrode formed of an electrically conductive material of at least parts of the installation component and providing a second electrode electrically insulated from the first electrode, at least the second electrode being applied on the installation component; and
printing at least one of the electrodes onto the installation component using one of the following processes:
a) an airbrush printing process;
b) a pad printing process; or
c) a screen printing process.

7. A tank for a urea-water solution, the tank comprising:
an apparatus according to claim 5;
said cap of the apparatus configured to close off an opening in the tank for extracting the urea-water solution.

8. The tank according to claim 7, which further comprises a tank base in which said opening is formed.

9. A motor vehicle, comprising:
a tank for a urea-water solution;
said tank including an apparatus according to claim 5;
said cap of the apparatus configured to close off an opening in the tank for extracting the urea-water solution; and
a controller connected at least to said first electrode and to said second electrode.
